(19) United States
(12) Patent Application Publication
(10) Pub. No.: US 2013/0325152 A1
(43) Pub. Date: Dec. 5, 2013

(54) PARAMETER SETTING DEVICE AND PARAMETER SETTING SYSTEM

(71) Applicants: Kenji Tobori, Chiyoda-ku (JP); Tadataka Asakawa, Chiyoda-ku (JP); Koichi Furusawa, Chiyoda-ku (JP); Tatsuya Mabuchi, Chiyoda-ku (JP); Naoki Koide, Nagoya-shi (JP)

(72) Inventors: Kenji Tobori, Chiyoda-ku (JP); Tadataka Asakawa, Chiyoda-ku (JP); Koichi Furusawa, Chiyoda-ku (JP); Tatsuya Mabuchi, Chiyoda-ku (JP); Naoki Koide, Nagoya-shi (JP)

(73) Assignee: MITSUBISHI ELECTRIC CORPORATION, Chiyoda-ku, Tokyo (JP)

(21) Appl. No.: 14/000,640

(22) PCT Filed: May 17, 2011
(86) PCT No.: PCT/JP2011/061343

§ 371 Date: Aug. 21, 2013

(51) Int. Cl. G05B 19/02

(52) U.S. Cl. CPC G05B 19/02
USPC 700/86

(57) ABSTRACT

A parameter setting device includes reference-format definition data for specifying setting items of a parameter regarding a first unit of a predetermined model and a predetermined version, differential-format definition data for specifying setting items of a parameter regarding a second unit of a model or a version different from the model or the version of the first unit with a difference from the reference-format definition data, a reference-data access unit and a differential-data access unit that select, when a parameter-setting target unit is the first unit, the reference-format definition data, and select, when the parameter-setting target unit is the second unit, both the reference-format definition data and the differential-format definition data, and a parameter conversion unit that interprets the parameter setting data based on the selected format definition data.

### FIELD

The present invention relates to a parameter setting device and a parameter setting system for setting parameters for a unit that constitutes a programmable controller.

### BACKGROUND

As for a CPU unit that performs an overall control of a programmable controller (PLC), highly-functional models have been developed and released to the market one after another, in order to meet demands from users. Furthermore, not only a new model is added, but also version upgrade of each model is frequently performed.

The CPU unit has parameters related to the operation of a PLC, such as an execution cycle of a user program, the backup timing of a device memory, and a usage range of the device memory. The user can perform setting of the parameters of the CPU unit by connecting a parameter setting device to the CPU unit.

In the CPU unit, setting items or a setting range of the parameter may be changed due to addition of a model or version upgrade of the model. Therefore, the version of the parameter setting device needs to be upgraded by connecting it to the Internet or the like according to the addition and change of the parameter; however, it is quite a heavy load for a user to keep the parameter setting device used in the actual field constantly to the latest state.

In contrast thereto, for example, it can be considered to prepare definition information for creating a setting screen for each model number and version of the CPU unit, so that a user can specify the model number and the version of a unit to be set, acquire the definition information corresponding to the model number and the version, and create the setting screen based on the acquired definition information (see, for example, Patent Literature 1).

### CITATION LIST

### Patent Literature

Patent Literature 1: Japanese Patent Application Laid-open No. 2007-95107

### SUMMARY

### Technical Problem

However, in terms of the memory usage amount, it is not effective to store definition information of all CPU units in a parameter setting device as the conventional technique mentioned above. Furthermore, when the definition information is to be stored in the CPU unit, the memory of the CPU unit is stressed, which may lead to a serious problem as a product.

The present invention has been achieved in view of the above problems, and an object of the present invention is to provide a parameter setting device and a parameter setting system with which parameters of units of as many models and versions as possible can be set with a storage capacity as small as possible.

### Solution to Problem

In order to solve the aforementioned problems, a parameter setting device for setting parameters for a unit that constitutes a programmable controller according to one aspect of the present invention is configured in such a manner as to include: reference-format definition data for specifying setting items of a parameter regarding a first unit of a predetermined model and a predetermined version; differential-format definition data for specifying setting items of a parameter regarding a second unit of a model or a version different from the model or the version of the first unit with a difference from the reference-format definition data; a format-definition-data selection unit that determines whether a parameter-setting target unit is the first unit or the second unit, when it is determined that the parameter-setting target unit is the first unit, selects the reference-format definition data, and when it is determined that the parameter-setting target unit is the second unit, selects both the reference-format definition data and the differential-format definition data; and a parameter conversion unit that receives an input of parameter setting data, interprets the received parameter setting data based on format definition data selected by the format-definition-data selection unit, and sets the interpreted parameter for the parameter-setting target unit.

### Advantageous Effects of Invention

The parameter setting device and the parameter setting system according to the present invention are configured to include format definition data for each unit as a difference from reference-format definition data, and thus parameters of units of as many models and versions as possible can be set with a storage capacity as small as possible.

### BRIEF DESCRIPTION OF DRAWINGS

FIG. 1 depicts a configuration of a parameter setting system according to a first embodiment.

FIG. 2 is an explanatory diagram of a functional configuration of the parameter setting system according to the first embodiment.

FIG. 3 is an explanatory diagram of an example of reference-parameter definition data.

FIG. 4 is an explanatory diagram of an example of a setting screen.

FIG. 5 is an explanatory diagram of an example of a structure defined by reference-format definition data.

FIG. 6 is an explanatory diagram of an operation in which a setting screen of a parameter is displayed on a display unit.

FIG. 7 is a flowchart for explaining an operation in which a parameter setting value is set in a CPU unit.

FIG. 8 depicts a configuration of a parameter setting system according to a second embodiment.

FIG. 9 is a flowchart for explaining an operation of a firmware version-upgrade device at the time of version upgrade of firmware.

### DESCRIPTION OF EMBODIMENTS

Exemplary embodiments of a parameter setting device and a parameter setting system according to the present invention will be explained below in detail with reference to the accompanying drawings. The present invention is not limited to the embodiments.

### First Embodiment

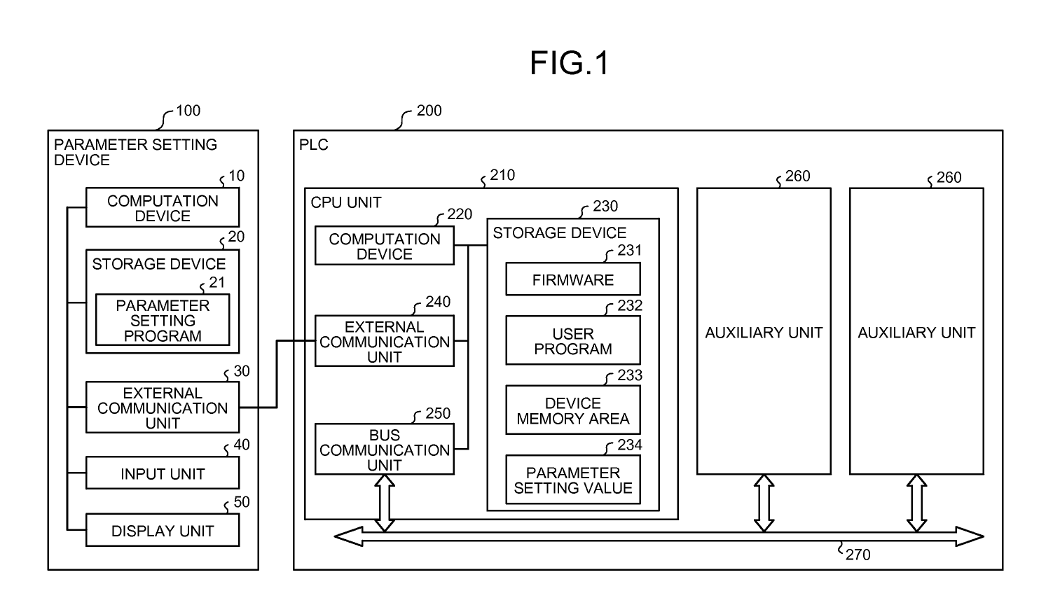

FIG. 1 depicts a configuration of a parameter setting system according to a first embodiment of the present invention. As shown in FIG. 1, the parameter setting system according to the first embodiment of the present invention includes a parameter setting device 100 and a PLC 200 connected to each other with a communication line.

The PLC 200 includes a CPU unit 210 and a plurality (in this case, two) of auxiliary units 260 connected to each other with a bus 270. The auxiliary units 260 are units for implementing various functions, and what types of auxiliary units 260 are used is determined according to the usage of the PLC 200. For example, the auxiliary units 260 include a temperature adjusting unit, a positioning unit, an analog input unit, and the like. The CPU unit 210 controls the auxiliary units 260 by performing a data communication with the auxiliary units 260 via the bus 270.

The CPU unit 210 includes a computation device 220, a storage device 230, an external communication unit 240 and a bus communication unit 250. The computation device 220, the storage device 230, the external communication unit 240, and the bus communication unit 250 are mutually connected with an internal bus.

The storage device 230 is constituted with a ROM (Read Only Memory) and a RAM (Random Access Memory). The storage device 230 stores therein firmware 231 as a system program of the CPU unit 210, a user program 232 created by a user to execute a control of the auxiliary units 260 as desired, and a parameter setting value 234. The storage device 230 further includes a device memory area 233 for storing therein input/output data (a device) exchanged with the auxiliary units 260.

The computation device 220 is constituted with a CPU (Central Processing Unit), for example. The computation device 220 periodically executes the user program 232 on the firmware 231, and reflects an execution result on the device value in the device memory area 233 for each cycle of the execution. The parameter setting value 234 is a specific value for specifying an operation exerted on the firmware 231, which is set to one or more than one setting items. The setting item of the parameter includes, for example, an execution cycle of the user program 232, a usage area of the device memory area 233, a backup timing of the device memory area 233, and the like.

The external communication unit 240 is a communication interface for performing a communication with the parameter setting device 100. Although a communication method for the communication with the parameter setting device 100 is not particularly limited, for example, Ethernet®, USB (Universal Serial Bus) or the like can be adopted.

The bus communication unit 250 is a communication interface for performing a communication with the auxiliary units 260 via the bus 270.

The parameter setting device 100 includes a computation device 10, a storage device 20, an external communication unit 30, an input unit 40, and a display unit 50, which is equivalent to the configuration of a normal computer. The computation device 10, the storage device 20, the external communication unit 30, the input unit 40, and the display unit 50 are mutually connected with an internal bus.

The storage device 20 is constituted by a ROM, RAM, and the like, and stores therein a parameter setting program 21 that is a computer program for setting a parameter in the CPU unit 210. The computation device 10 is constituted by a CPU or the like, and executes the parameter setting program 21 stored in the storage device 20. Furthermore, such a configuration can also be adopted, in which the parameter setting program 21 is stored in a recording medium such as a disk or an external storage device and the computation device 10 loads the parameter setting program 21 stored in these media to the storage device 20. The external communication unit 30 is a communication interface for connecting to the CPU unit 210. The input unit 40 is an input device constituted with a mouse and a keyboard, and information inputted from the input unit 40 is sent to the computation device 10. The display unit 50 is a display unit such as a liquid crystal display, and displays display output data created by the computation device 10.

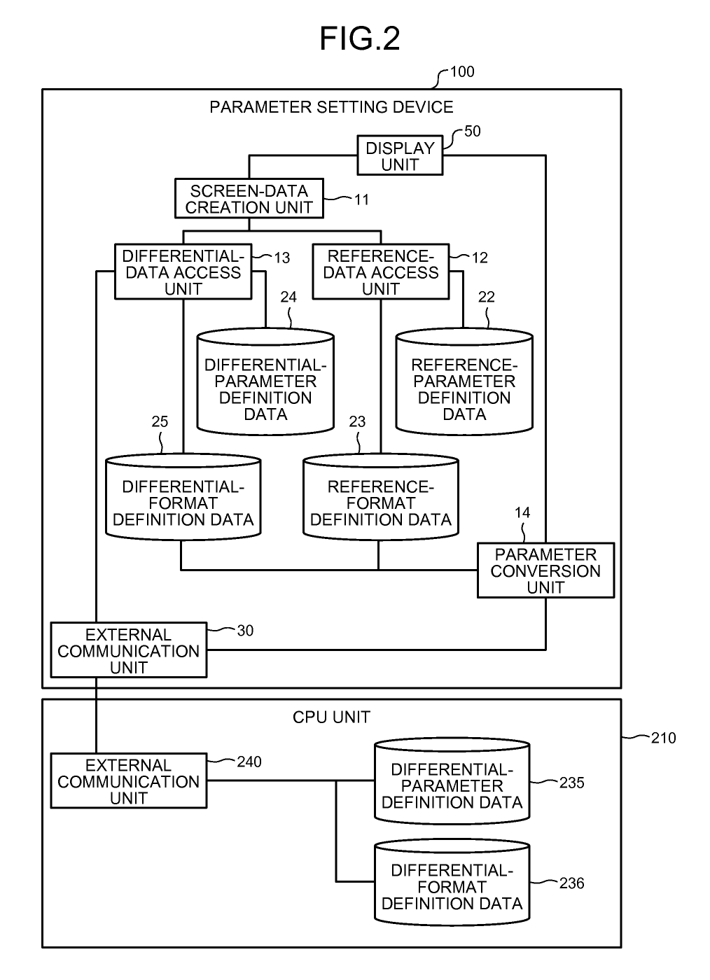

FIG. 2 is an explanatory diagram of a functional configuration of the parameter setting system according to the first embodiment.

The parameter setting device 100 includes a screen-data creation unit 11, a reference-data access unit 12, a differential-data access unit 13, a parameter conversion unit 14, reference-parameter definition data 22, reference-format definition data 23, differential-parameter definition data 24, and differential-format definition data 25. These functional constituent elements are created by the computation device 10 that executes the parameter setting program 21. Specifically, the screen-data creation unit 11, the reference-data access unit 12, the differential-data access unit 13, and the parameter conversion unit 14 are created in the computation device 10, and the reference-parameter definition data 22, the reference-format definition data 23, the differential-parameter definition data 24, and the differential-format definition data 25 are created in the storage device 20.

The parameter definition data is definition information for creating a setting screen including an input form of the parameter for each setting item. The input form is a component displayed on the display unit 50 to prompt a user to make an input, and is used to load information coupled in advance to the input form and a content inputted via the input form to the inside in an associated manner. The parameter definition data includes at least information for each setting item for identifying the setting item of the parameter, as information coupled to each input form. According to the first embodiment, because a required capacity of the storage device 20 is considerably increased if the parameter definition data is provided for each model number and version, a model number and a version that serve as a reference are determined, the parameter definition data related to the model number and the version of the reference (the reference-parameter definition data 22) is included, and the parameter definition data corresponding to another model number and version is provided as a difference from the reference-parameter definition data 22 (the differential-parameter definition data 24).

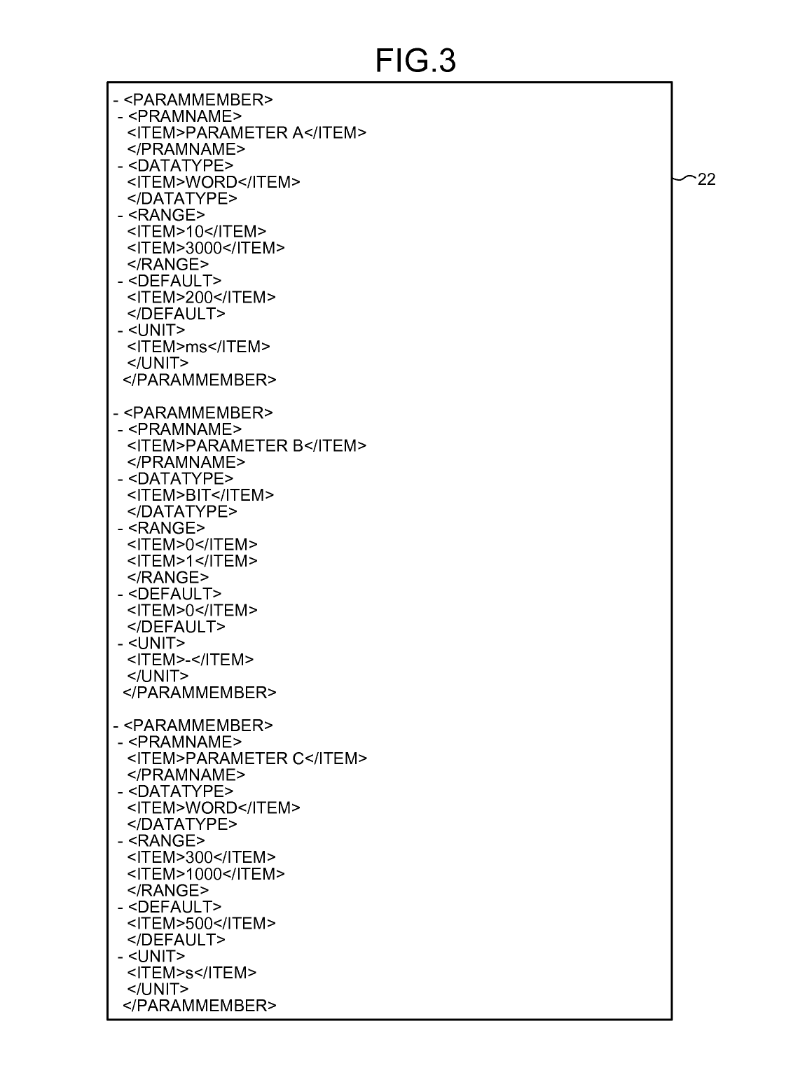

FIG. 3 is an explanatory diagram of an example of the reference-parameter definition data 22. According to this example, the reference-parameter definition data 22 is described by an XML, and includes fields respectively describing a type of data, a setting range of the parameter, an initial value, and a unit, for each setting item, as well as the name of the setting item as information for identifying the setting item of the parameter. For example, when only the setting range of the parameter B is different in a model and a version which are different from those targeted by the reference-parameter definition data 22, an XML file describing only the setting range of the parameter B is stored as the differential-parameter definition data 24 corresponding to the different model and version.

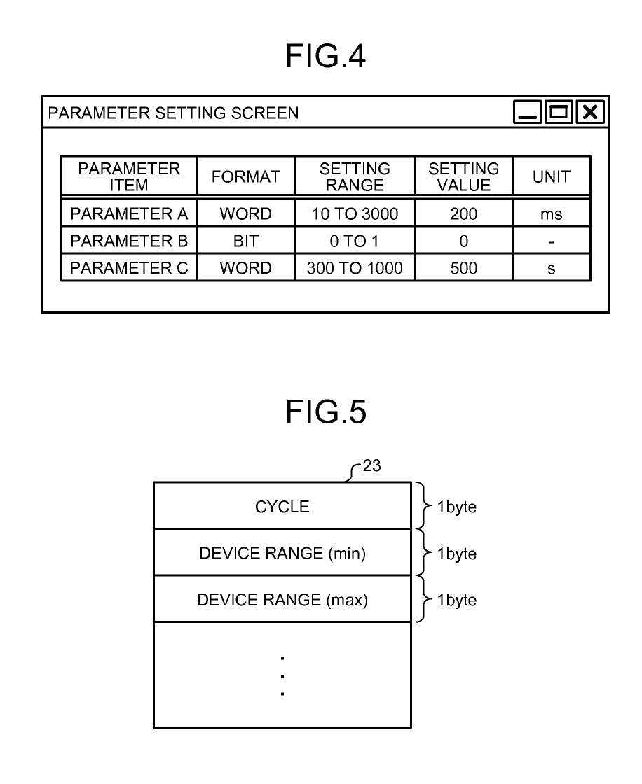

FIG. 4 is an explanatory diagram of an example of a setting screen created from the reference-parameter definition data 22 shown in FIG. 3. As shown in FIG. 4, according to the example of the setting screen, each display field is created based on the XML description shown in FIG. 3. The user can input the parameter for each setting item by editing a field of the “setting value”.

The format definition data is definition information for identifying the parameter setting value for each setting item from a list of data inputted as the parameter setting value from the input unit 40. In other words, the format definition data is information for specifying the setting item of the parameter related to the CPU unit 210. The format definition data includes a definition of a structure of data as information for identifying the parameter setting value. Also regarding the format definition data, the parameter setting device 100 is configured to include the format definition data related to the model number and the version serving as the reference (the reference-format definition data 23), and include format definition data related to another model number and version as a difference with respect to the reference-format definition data 23 (the differential-format definition data 25).

FIG. 5 is an explanatory diagram of an example of a structure defined by the reference-format definition data 23. According to the example shown in FIG. 5, the first 1 byte describes an execution cycle of the user program 232, the next 1 byte describes the minimum value of the range of the device memory area 233, and the second next 1 byte describes the maximum value of the range of the device memory area 233. For example, when the size of 2 bytes is required to describe the cycle in a model and a version which are different from those targeted by the reference-format definition data 23, definition information prepared with a 2-byte area to describe the cycle is stored as the differential-format definition data 25 corresponding to the different model and version.

In this example, the format definition data includes a definition of a decimal point position of the parameter setting value, as well as the definition of the structure. In the first embodiment, the parameter is set as an integer, rather than a real number, in order to make the storage capacity of the parameter setting value as small as possible. Therefore, a value inputted from the input unit 40 is sent to the computation device 10 as an integer. However, when the execution cycle of the user program 232 is reduced by an order of magnitude due to the improvement in its performance, for example, an increment of the setting gradation, which has been “1”, needs to be changed to “0.1”. Therefore, in order to make the step size of the setting changeable as desired, the definition of the decimal point position is included in the reference-format definition data 23 (and the differential-format definition data 25). That is, by defining the decimal point position on the format definition data, the computation device 10 can interpret the parameter setting value, which is sent as an integer, as a value intended by a user by changing the decimal point position.

In this manner, according to the first embodiment of the present invention, the reference-parameter definition data 22 and the reference-format definition data 23 are stored for a specific model and a specific version, and the differential-parameter definition data 24 and the differential-format definition data 25 are stored for another model and version. Although there can be a plurality of specific models and versions for which the reference-parameter definition data 22 and the reference-format definition data 23 are stored, in the following explanations, for the sake of simplicity, it is assumed that there are one specific model and one version serving as the reference.

The reference-data access unit 12 and the differential-data access unit 13 cooperate with each other to function as a format-definition-data selection unit that selects format definition data for setting the parameter for the CPU unit 210 and a parameter-definition-data selection unit that selects parameter definition data for creating the setting screen.

Specifically, the reference-data access unit 12 reads out the corresponding reference-parameter definition data 22 and the corresponding reference-format definition data 23 by using a model number and a version as search keys. The differential-data access unit 13 reads out the corresponding differential-parameter definition data 24 and the corresponding differential-format definition data 25 by using the model number and the version as search keys. When the corresponding differential-parameter definition data 24 and the corresponding differential-format definition data 25 cannot be found, the differential-data access unit 13 reads the corresponding data (differential-parameter definition data 235 or differential-format definition data 236) from the CPU unit 210 via the external communication unit 30.

The screen-data creation unit 11 creates the setting screen to be displayed on the display unit 50 from the read parameter definition data (the reference-parameter definition data 22, the differential-parameter definition data 24, and the differential-parameter definition data 235).

The parameter conversion unit 14 interprets the data structure and the decimal point position of the input parameter setting value based on the read format definition data (the reference-format definition data 23, the differential-format definition data 25, and the differential-format definition data 236), and sends the interpreted parameter setting value to the CPU unit 210 via the external communication unit 30. The parameter setting value sent to the CPU unit 210 is stored in the storage device 230.

As described above, the CPU unit 210 includes the differential-parameter definition data 235 and the differential-format definition data 236, so that the parameter setting device 100 can perform the setting of the parameter in the CPU unit 210 even when there is no differential-parameter definition data 24 or differential-format definition data 25 corresponding to its own CPU unit 210 in the parameter setting device 100. The differential-parameter definition data 235 and the differential-format definition data 236 are stored in advance in the storage device 230.

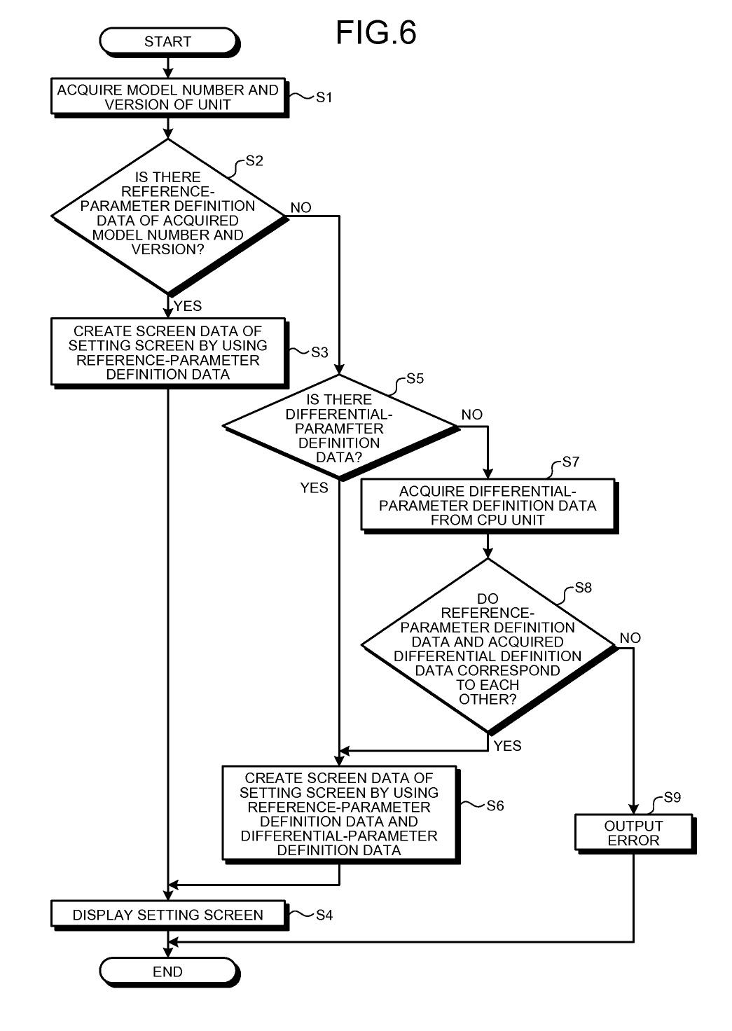

An operation of the first embodiment of the present invention is explained next. FIG. 6 is an explanatory diagram of the operation in which a setting screen of a parameter is displayed on the display unit 50.

First, as shown in FIG. 6, the reference-data access unit 12 accesses the connected CPU unit 210, and acquires the model number and the version of the CPU unit 210 (Step S1). It can be configured such that the model number and the version of the CPU unit 210 are, for example, stored in advance in the storage device 230, so that the reference-data access unit 12 can read out the model number and the version stored in the storage device 230.

The reference-data access unit 12 determines whether the reference-parameter definition data 22 for the CPU unit 210 of the acquired model number and version is included (Step S2). When it is determined that the reference-parameter definition data 22 for the CPU unit 210 of the acquired model number and version is included (YES at Step S2), the screen-data creation unit 11 creates the screen data of the setting screen by using the reference-parameter definition data 22 (Step S3), and displays the created screen data on the display unit 50 (Step S4), and the operation is ended.

When it is determined that the reference-parameter definition data 22 for the CPU unit 210 of the acquired model number and version is not included (NO at Step S2), the differential-data access unit 13 determines whether the differential-parameter definition data 24 of the acquired model number and version is included in the parameter setting device 100 (Step S5). When it is determined that the differential-parameter definition data 24 of the acquired model number and version is included (YES at Step S5), the screen-data creation unit 11 creates the screen data of the setting screen by using the differential-parameter definition data 24 and the reference-parameter definition data 22 (Step S6). After Step S6, the process shifts to Step S4.

When it is determined that the differential-parameter definition data 24 of the acquired model number and version is not included in the parameter setting device 100 (NO at Step S5), the differential-data access unit 13 accesses the CPU unit 210, and acquires the differential-parameter definition data 235 from the CPU unit 210 (Step S7). The differential-data access unit 13 then determines whether the acquired differential-parameter definition data 235 corresponds to the reference-parameter definition data 22 stored in its own parameter setting device 100 (Step S8). The fact that the differential-parameter definition data 235 and the reference-parameter definition data 22 correspond to each other means that the differential-parameter definition data 235 has been created as the difference from the reference-parameter definition data 22. In order to make it possible to determine whether these two data correspond to each other, for example, the model and the version of the reference-parameter definition data serving as a basis can be recorded in advance in the differential-parameter definition data 235. That is, it suffices that the differential-data access unit 13 compares the model and the version recorded in the differential-parameter definition data 235 with the model and the version targeted by the reference-parameter definition data 22.

When it is determined that the acquired differential-parameter definition data 235 and the reference-parameter definition data 22 correspond to each other (YES at Step S8), the process shifts to Step S6, and the screen-data creation unit 11 creates the screen data of the setting screen by using the differential-parameter definition data 235 and the reference-parameter definition data 22. When it is determined that the acquired differential-parameter definition data 235 and the reference-parameter definition data 22 do not correspond to each other (NO at Step S8), the screen-data creation unit 11 displays an error on the display unit 50 (Step S9), and the operation is ended.

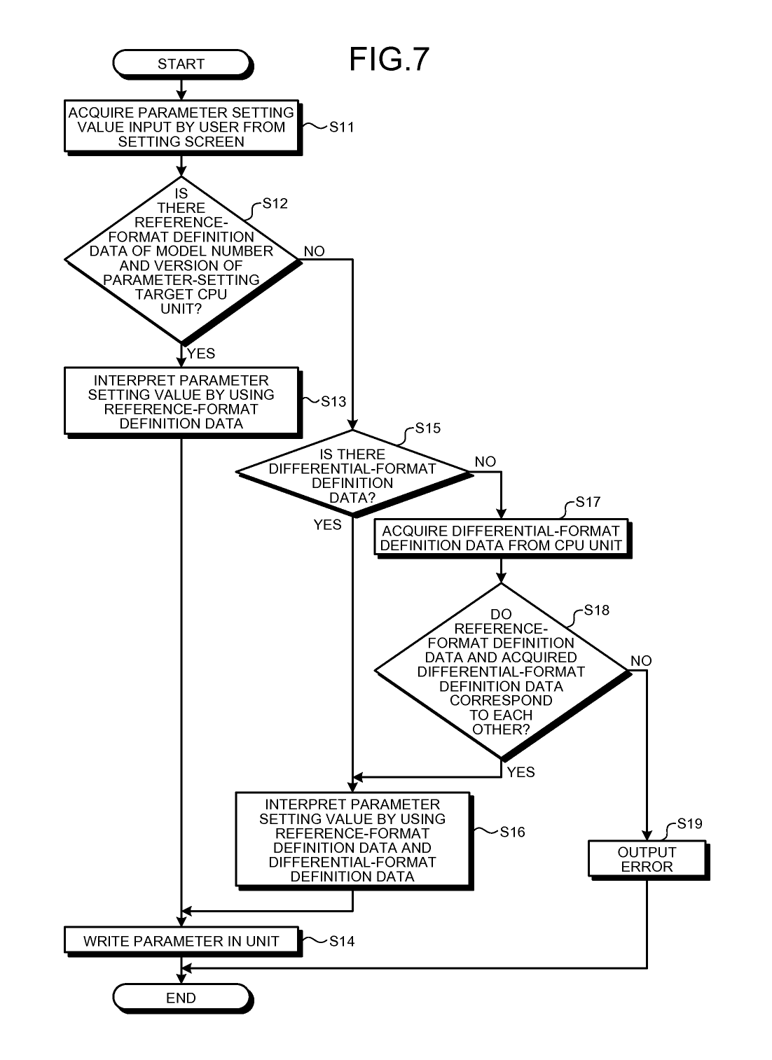

FIG. 7 is a flowchart for explaining an operation in which a parameter setting value is set in the CPU unit 210.

First, as shown in FIG. 7, the parameter conversion unit 14 acquires the parameter setting value inputted from the input unit 40 via the setting screen displayed on the display unit 50 (Step S11). The reference-data access unit 12 then determines whether the reference-format definition data 23 of the model number and the version of the CPU unit 210 for which the parameter is to be set is included (Step S12). When it is determined that the reference-format definition data 23 of the model number and the version is included (YES at Step S12), the parameter conversion unit 14 interprets the input parameter setting value by using the reference-format definition data 23, identifies the input parameter setting value for each setting item, and converts the decimal point position of the parameter setting value for each setting item (Step S13). The parameter conversion unit 14 then writes the converted parameter setting value in the CPU unit 210 (Step S14), and the operation is ended.

When it is determined that the reference-format definition data 23 of the model number and the version of the CPU unit 210 for which the parameter is to be set is not included (NO at Step S12), the differential-data access unit 13 determines whether the differential-format definition data 25 of the model number and the version is included in the parameter setting device 100 (Step S15). When it is determined that the differential-format definition data 25 of the model number and the version is included (YES at Step S15), the parameter conversion unit 14 identifies the input parameter setting value for each setting item by using the differential-format definition data 25 and the reference-format definition data 23, and converts the decimal point position of the parameter setting value for each setting item (Step S16). The process then shifts to Step S14.

When it is determined that the differential-format definition data 25 of the model number and the version of the CPU unit 210 for which the parameter is to be set is not included in the parameter setting device 100 (NO at Step S15), the differential-data access unit 13 accesses the CPU unit 210, and acquires the differential-format definition data 236 from the CPU unit 210 (Step S17). The differential-data access unit 13 then determines whether the acquired differential-format definition data 236 corresponds to the reference-format definition data 23 stored in its own parameter setting device 100 (Step S18). The fact that the differential-format definition data 236 and the reference-format definition data 23 correspond to each other means that the differential-format definition data 236 has been created as the difference from the reference-format definition data 23. In order to make it possible to determine whether these two data correspond to each other, for example, the model and the version of the reference-format definition data serving as a basis can be recorded in advance in the differential-format definition data 236.

When it is determined that the acquired differential-format definition data 236 and the reference-format definition data 23 correspond to each other (YES at Step S18), the process shifts to Step S16, and the parameter conversion unit 14 identifies the input parameter setting value for each setting item by using the differential-format definition data 236 and the reference-format definition data 23, and converts the decimal point position of the parameter setting value for each setting item. When it is determined that the acquired differential-format definition data 236 and the reference-format definition data 23 do not correspond to each other (NO at Step S8), the screen-data creation unit 11 displays an error on the display unit 50 (Step S19), and the operation is ended.

In this manner, according to the first embodiment of the present invention, the parameter setting device 100 is configured to include the format definition data for each unit as the difference from the reference-format definition data 23, and thus parameters of units of as many models and versions as possible can be set with a storage capacity of the storage device 20 as small as possible.

Also regarding the parameter definition data for creating the setting screen including the input form for each setting item, it is configured to hold the parameter definition data for each unit as the difference from the reference-parameter definition data 22, and thus parameters of units of as many models and versions as possible can be set with a storage capacity of the storage device 20 as small as possible.

The CPU unit 210 holds the differential-format definition data 236 that is the difference from the reference-format definition data 23, and the parameter setting device 100 is configured to use the differential-format definition data 236 included in the CPU unit 210, and thus the parameter setting can be performed even when the parameter setting device 100 does not contain the format definition data for the CPU unit 210.

The CPU unit 210 holds the differential-parameter definition data 235 that is the difference from the reference-parameter definition data 22, and the parameter setting device 100 is configured to use the differential-parameter definition data 235 held in the CPU unit 210, and thus the parameter setting can be performed even when the parameter setting device 100 does not contain the parameter definition data for the CPU unit 210.

### Second Embodiment

In a CPU unit, there are cases where the version of firmware is upgraded. According to the second embodiment, when the version of firmware is upgraded, differential data stored in the CPU unit is also upgraded simultaneously.

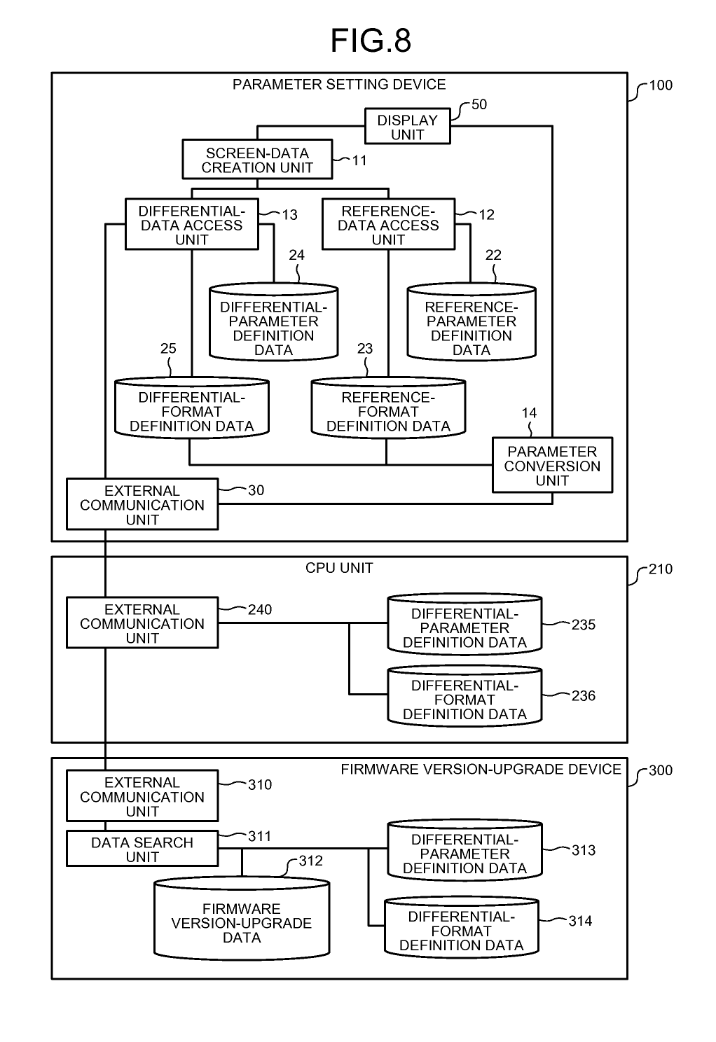

FIG. 8 depicts the configuration of a parameter setting system according to the second embodiment of the present invention. As shown in FIG. 8, the parameter setting system according to the second embodiment has a configuration in which a firmware version-upgrade device 300 is added to the first embodiment. The firmware version-upgrade device 300 is implemented by a server-type computer including a computation device, a storage device, and an external communication unit (an external communication unit 310).

As shown in FIG. 8, the firmware version-upgrade device 300 includes the external communication unit 310, a data search unit 311, firmware version-upgrade data 312, differential-parameter definition data 313, and differential-format definition data 314.

The external communication unit 310 is a communication interface for performing communications with the CPU unit 210, and is connected to the external communication unit 240 of the CPU unit 210.

For example, the firmware version-upgrade data 312 is a difference file between versions of the firmware 231.

The data search unit 311 performs version upgrade of the firmware 231 of the CPU unit 210 for which the version is to be upgraded, by using the firmware version-upgrade data 312, reads out the differential-parameter definition data 313 and the differential-format definition data 314, and respectively overwrites the differential-parameter definition data 235 and the differential-format definition data 236 in the CPU unit 210 by using the thus read-out data.

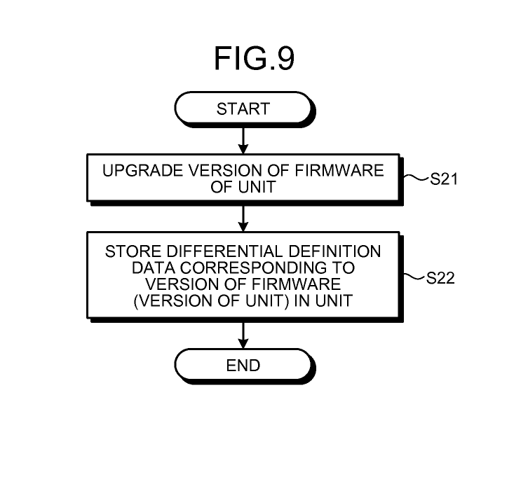

FIG. 9 is a flowchart for explaining the operation of the firmware version-upgrade device 300 at the time of version upgrading of the firmware 231. As shown in FIG. 9, when the operation is started, the data search unit 311 performs version upgrade of the firmware 231 of the CPU unit 210 for which the version of the firmware is to be upgraded, by using the firmware version-upgrade data 312 (Step S21). The data search unit 311 then reads out the differential-parameter definition data 313 and the differential-format definition data 314 of the version of the firmware 231, and respectively overwrites the differential-parameter definition data 235 and the differential-format definition data 236 in the CPU unit 210, by using the thus read-out data (Step S22), and the operation is ended.

In this manner, according to the second embodiment of the present invention, when the version of the firmware of the CPU unit 210 is upgraded, the firmware version-upgrade device 300 is configured to update the differential-format definition data 236 of the CPU unit 210, and thus when the version of the firmware of the CPU unit 210 is upgraded, it is possible to prevent a discrepancy from being generated between the version of the firmware and the version of the differential-format definition data 236.

Furthermore, when the version of the firmware is upgraded, the firmware version-upgrade device 300 is configured to update the differential-parameter definition data 235, and thus it is possible to prevent the discrepancy from being generated between the version of the firmware and the version of the differential-parameter definition data 235.

In the explanations of the first and second embodiments, there has been explained a method in which parameters are set in the CPU unit 210. When the parameters to be set are provided in the auxiliary unit 260, parameter setting for the auxiliary unit 260 can be performed by applying the explanations of the CPU unit 210 to the auxiliary unit 260 as they are. When the parameter setting is performed in the auxiliary unit 260 from the parameter setting device 100, transfer of the parameter setting value and transfer of the model number and the version of the auxiliary unit 260 can be performed via the external communication unit 240 and the bus 270.

### INDUSTRIAL APPLICABILITY

As described above, the parameter setting device and the parameter setting system according to the present invention are preferable to be applied as a parameter setting device and a parameter setting system for setting parameters for a unit that constitutes a programmable controller.

### REFERENCE SIGNS LIST

10 computation device

11 screen-data creation unit

12 reference-data access unit

13 differential-data access unit

14 parameter conversion unit

20 storage device

21 parameter setting program

22 reference-parameter definition data

23 reference-format definition data

24 differential-parameter definition data

25 differential-format definition data

30 external communication unit

40 input unit

50 display unit

100 parameter setting device

200 PLC

210 CPU unit

220 computation device

230 storage device

231 firmware

232 user program

233 device memory area

234 parameter setting value

235 differential-parameter definition data

236 differential-format definition data

240 external communication unit

250 bus communication unit

260 auxiliary unit

270 bus

300 firmware version-upgrade device

310 external communication unit

311 data search unit

312 firmware version-upgrade data

313 differential-parameter definition data

314 differential-format definition data

1. A parameter setting device for setting parameters for a unit that constitutes a programmable controller, comprising:
reference-format definition data for specifying setting items of a parameter regarding a first unit of a predetermined model and a predetermined version;
differential-format definition data for specifying setting items of a parameter regarding a second unit of a model or a version different from the model or the version of the first unit with a difference from the reference-format definition data;
a format-definition-data selection unit that
determines whether a parameter-setting target unit is the first unit or the second unit,
when it is determined that the parameter-setting target unit is the first unit, selects the reference-format definition data, and
when it is determined that the parameter-setting target unit is the second unit, selects both the reference-format definition data and the differential-format definition data; and
a parameter conversion unit that receives an input of parameter setting data, interprets the received parameter setting data based on format definition data selected by the format-definition-data selection unit, and sets the interpreted parameter for the parameter-setting target unit.

2. The parameter setting device according to claim 1, further comprising:
reference-parameter definition data for creating a setting screen having an input form of the parameter regarding the first unit for each setting item;
differential-parameter definition data for creating a setting screen having an input form of the parameter regarding the second unit for each setting item, the differential-parameter definition data being described with a difference from the reference-parameter definition data;
a parameter-definition-data selection unit that
determines whether a parameter-setting target unit is the first unit or the second unit,
when it is determined that the parameter-setting target unit is the first unit, selects the reference-parameter definition data, and
when it is determined that the parameter-setting target unit is the second unit, selects both the reference-parameter definition data and the differential-parameter definition data; and
a screen-data creation unit that creates the setting screen of the parameter based on parameter definition data selected by the parameter-definition-data selection unit.

3. The parameter setting device according to claim 1, wherein
the reference-format definition data and the differential-format definition data include decimal-point position information indicating a decimal point position of the parameter for each setting item, and
the parameter conversion unit interprets the decimal point position of the parameter based on the decimal-point position information.

4. A parameter setting system comprising:
a parameter setting device for setting parameters for a unit that constitutes a programmable controller; and
a parameter-setting target unit having a parameter to be set by the parameter setting device, wherein
the parameter setting device includes
reference-format definition data for specifying setting items of a parameter regarding a first unit of a predetermined model and a predetermined version,
first differential-format definition data for specifying setting items of a parameter regarding a second unit of a model or a version different from the model or the version of the first unit with a difference from the reference-format definition data,
a format-definition-data selection unit that
determines whether the parameter-setting target unit is the first unit, the second unit, or none of the first unit and the second unit,
when it is determined that the parameter-setting target unit is the first unit, selects the reference-format definition data, and
when it is determined that the parameter-setting target unit is the second unit, selects both the reference-format definition data and the first differential-format definition data, and
a parameter conversion unit that receives an input of parameter setting data, interprets the received parameter setting data based on format definition data selected by the format-definition-data selection unit, and sets the interpreted parameter for the parameter-setting target unit,
wherein, the parameter-setting target unit includes second differential-format definition data for specifying setting items of a parameter included in its own unit with a difference from the reference-format definition data, and
when it is determined that the parameter-setting target unit is none of the first unit and the second unit, the format-definition-data selection unit selects the reference-format definition data and the second differential-format definition data included in the parameter-setting target unit.

5. The parameter setting system according to claim 4, wherein
the parameter setting device further includes
reference-parameter definition data for creating a setting screen having an input form of the parameter regarding the first unit for each setting item,
first differential-parameter definition data for creating a setting screen having an input form of the parameter regarding the second unit for each setting item, the first differential-parameter definition data being described with a difference from the reference-parameter definition data,
a parameter-definition-data selection unit that
determines whether the parameter-setting target unit is the first unit, the second unit, or none of the first unit and the second unit,
when it is determined that the parameter-setting target unit is the first unit, selects the reference-parameter definition data, and
when it is determined that the parameter-setting target unit is the second unit, selects both the reference-parameter definition data and the first differential-parameter definition data, and
a screen-data creation unit that creates the setting screen of the parameter based on parameter definition data selected by the parameter-definition-data selection unit,
wherein the parameter-setting target unit further includes second differential-parameter definition data for creating a setting screen having an input form of the parameter of its own unit for each setting item, the second differential-parameter definition data being described with a difference from the reference-parameter definition data, and
when it is determined that the parameter-setting target unit is none of the first unit and the second unit, the parameter-definition-data selection unit selects the reference-parameter definition data and the second differential-parameter definition data included in the parameter-setting target unit.

6. The parameter setting system according to claim 4, further comprising a firmware version-upgrade device that is connected to the parameter-setting target unit and upgrades the version of firmware of the unit, wherein
upon upgrading the firmware of the parameter-setting target unit, the firmware version-upgrade device updates the second differential-format definition data included in the parameter-setting target unit.

7. The parameter setting system according to claim 5, further comprising a firmware version-upgrade device that is connected to the parameter-setting target unit and upgrades a version of firmware of the unit, wherein
upon upgrading the firmware of the parameter-setting target unit, the firmware version-upgrade device updates the second differential-format definition data and the second differential-parameter definition data included in the parameter-setting target unit.

8. The parameter setting system according to claim 4, wherein
the reference-format definition data, the first differential-format definition data, and the second differential-format definition data include decimal-point position information indicating a decimal point position of the parameter for each setting item, and
the parameter conversion unit interprets the decimal point position of the parameter based on the decimal-point position information.
